(19) United States
(12) Patent Application Publication
(10) Pub. No.: US 2008/0007079 A1
(43) Pub. Date: Jan. 10, 2008

(54) CONSOLE ASSEMBLY FOR A VEHICLE

(75) Inventors: Alan Sturt, West Bloomfield, MI (US); Jason Gamache, Romeo, MI (US); James A. Mulvihill, Berkley, MI (US); Jerome David Joler, Rochester Hills, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: LEAR CORPORATION, Southfield, MI (US)

(21) Appl. No.: 11/456,367

(22) Filed: Jul. 10, 2006

(51) Int. Cl. B60R 7/04

(52) U.S. Cl. 296/24.34

(57) ABSTRACT

A console assembly for use in a passenger seating area of a vehicle includes first and second console modules configured for installment in the passenger seating area. Each console module includes a housing having a storage area defined therein, wherein the first and second console modules cooperate with and are positionable relative to each other to provide additional storage in the vehicle. A base disposed adjacent a floor of the passenger seating area of the vehicle is configured to receive the first and second console modules. In one aspect, the first and second console modules may be slidably connected to the base and are independently positionable forward and rearward on the base. In another aspect, the first and second console modules include a first end and opposing second end sized for connection to and repositionable on the base.

### BACKGROUND OF THE INVENTION

1. Field of the Invention

The present invention relates generally to a console assembly for a passenger seating area of a vehicle.

2. Background Art

Vehicle manufacturers continue to develop storage containers and devices for the passenger compartments of vehicles to accommodate occupant's personal items and automotive components. Several current storage containers are designed to fit within specified areas of the passenger compartment and allow limited access to items stored therein.

Many automotive vehicles include a center console or other storage device disposed between passenger seats in the front passenger compartment of the vehicle. Typically, the center console is disposed between the driver and passenger seats in a forward seating area of the vehicle. However, it is common in larger vehicles, such as sport utility vehicles and vans, to provide center consoles between the second and/or third row passenger seating areas.

These consoles typically comprise a console base that may be secured to the floor, releasably mounted to the floor or pivotally connected between the seats, a storage cavity formed in the console base to retain items during travel and an armrest pivotally connected to the console base extending generally horizontally across the storage cavity. One limitation of current console assemblies is that the storage area and occupant accessible portions of the console can sometimes be obscured or inaccessible to various portions of the passenger compartments.

It would be advantageous to provide a storage console assembly for a vehicle which offers a wide variety of storage options while allowing access to items stored therein to most occupants of the vehicle. It is also desirable to provide a console assembly having one or more reconfigurable modules for use throughout the vehicle seating area.

### SUMMARY OF THE INVENTION

The present invention provides a console assembly for use in a passenger seating area of a vehicle. The console assembly comprises first and second console modules configured for installment in the passenger seating area. Each console module includes a housing having a storage area defined therein, wherein the first and second console modules cooperate with and are positionable relative to each other to provide additional storage in the vehicle. A base disposed adjacent a floor of the passenger seating area of the vehicle is configured to receive the first and second console modules.

In one aspect of the present invention, the first and second console modules may be slidably connected to the base and independently positionable forward and rearward on the base. In another aspect of the present invention, the first and second console modules include a first end and opposing second end sized for connection to and may be repositionable on the base to provide a variety of storage solutions and a storage area therebetween. The first and second console modules may be positioned in a nesting arrangement wherein the first end of one console module may be positioned adjacent the second end of another console module. Alternatively, the modules may be positioned in a mating arrangement such that the second ends of each of the first and second modules are positioned adjacent each other to form a storage area therebetween.

Other features and advantages of the present invention will be readily appreciated and better understood after reading the subsequent description when considered in connection with the accompanying drawings.

### BRIEF DESCRIPTION OF THE DRAWINGS

FIG. 1 is a perspective view of a first aspect of a console assembly for a passenger seating area of a vehicle in accordance with the present invention;

FIG. 2 is a perspective view of first and second console modules of the console assembly in a forward position;

FIG. 3 is a perspective view of the first and second console modules positioned adjacent each other in an aft position;

FIG. 4 is a perspective view of the first aspect of the console assembly of the present invention with the first and second console modules extended away from each other;

FIG. 5a is side plan view of a first module mounting arrangement for use in connection with the console assembly of the present invention;

FIG. 5b is side plan view of a second module mounting arrangement for use in connection with the console assembly of the present invention;

FIG. 5c is side plan view of the second module mounting arrangement including electrical contacts;

FIG. 5d is side plan view of another mounting arrangement for use in connection with the console assembly of the present invention;

FIG. 6 is a perspective view of a second aspect of the console assembly in accordance with the present invention;

FIG. 7 is a perspective view of one console module mounting arrangement in accordance with the present invention;

FIG. 8 is a perspective view of the second aspect of the console assembly configured to receive a removable storage module;

FIG. 9 is a perspective view of another console mounting arrangement in accordance with the present invention; and

FIG. 10 is a perspective view of yet another console mounting arrangement in accordance with the present invention.

### DETAILED DESCRIPTION OF THE PREFERRED EMBODIMENT(S)

Referring now to the Figures, a console assembly for use in the passenger seating area of a motor vehicle in accordance with the present invention is disclosed. It is understood that the console assembly may be used in either the front or rear passenger seating areas. For purposes of this disclosure, the restraint system will be installed in a rear passenger seating area between a pair of front passenger seats.

In the following description, various operating parameters and components are described for a number of constructed embodiments. These specific parameters and components are included as examples and are not meant to be limiting. More specifically, directional language such as “left”, “right”, “above”, “below”, “upper”, “lower” and words of similar import designate directions shown in the drawings. Such directional terminology is used for clarity and is not intended to strictly limit the orientation of any aspect of the invention to a particular plane or direction.

Referring now to Figures, a console assembly 10 is disposed between a pair of passenger seats 12, 14 in the passenger compartment of the vehicle in accordance with the present invention. Passenger seats 12, 14 are shown to include bucket seats with the passenger side bucket seats being illustrated in phantom so as to provide a clear view of the console assembly 10. The present invention, however, contemplates the use of any number and type of seats, including bench seats, and is not intended to be limited to the non-limiting aspect of the present invention shown in the Figures.

Console assembly 10 includes a first console module 16 and a second console module 18 disposed adjacent the floor of the passenger compartment of the vehicle. It is understood that first and second console modules may be configured to be disposed on and secured to the floor of the passenger compartment of the vehicle or other support structure. It is also understood that the console assembly may be positioned anywhere within the passenger seating area of the vehicle.

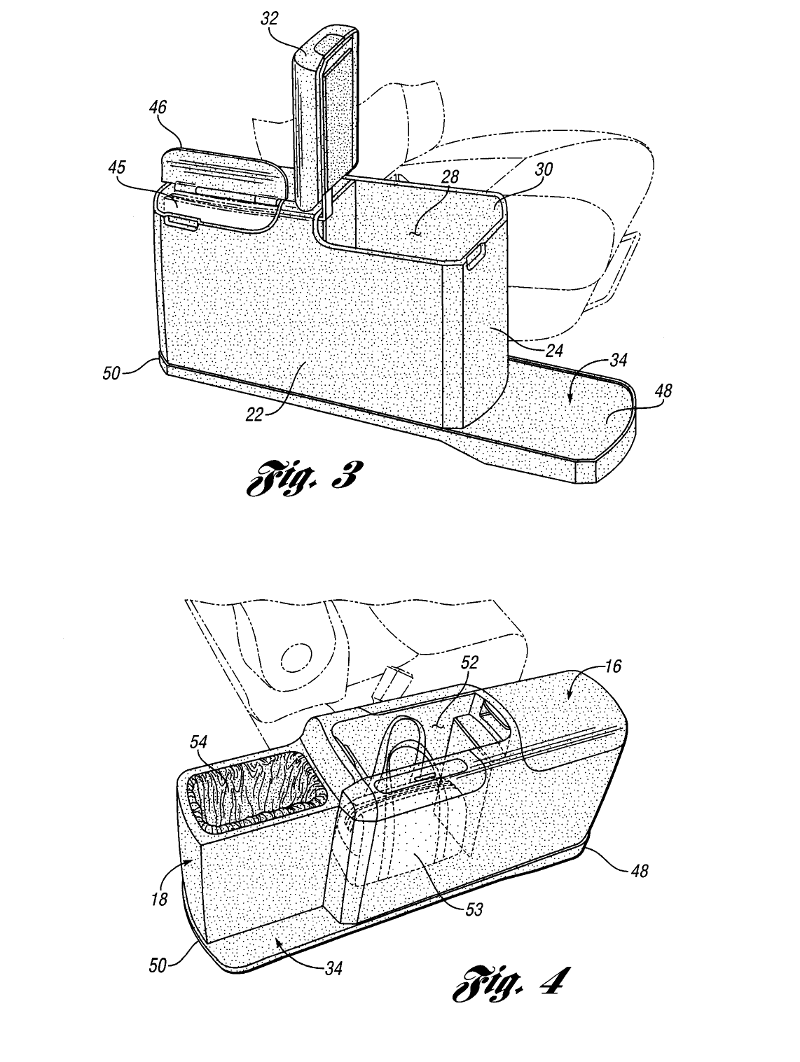

Each console module 16, 18 generally includes a housing having a lower surface 20, front and rear surfaces and a pair of opposing side surfaces 22, 24 extending upward from the lower surface 20. It is understood that the console module housing may be configured to include a variety of storage compartments or areas, such as storage bins or cup holders, formed on an external portion of the console housing. As shown in FIG. 3, a storage area 28 is formed by and between the housing surfaces. The storage area 28 may be generally accessed through a top surface 30 of the console module.

A cover 32 may be adjustably positioned relative to the top surface 30 of the console module 16, 18. Cover 32 may be configured to act as an armrest which is positionable between a stowed position disposed at least partially adjacent the top surface 30 of the console module and a deployed position. The storage area 28 is generally configured to receive and store a variety of personal items, including mobile telephones, sunglasses, purses, bags or the like. Storage area 28 may also be configured to receive electronic components or other passenger convenience devices.

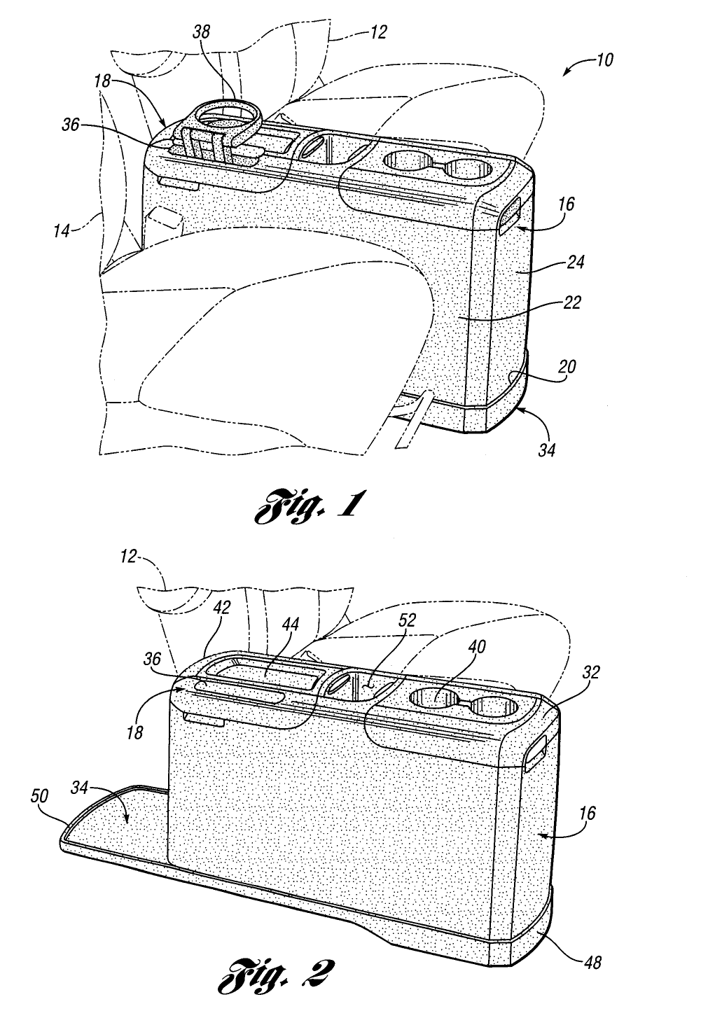

Referring now to FIGS. 1-4, a first aspect of the console assembly of the present invention is illustrated and disclosed. Console assembly 10 includes a first console module 16 and a second console module 18 that may be movably supported on or connected to a base or support surface 34. FIGS. 1-3 illustrate the first and second console modules 16, 18 disposed adjacent each other on base 34. When placed adjacent each other in a nesting condition, first and second console modules 16, 18 define an open storage space 52 therebetween. First and second console modules may also be configured to cooperate with the instrument panel of the vehicle.

First and second console modules 16, 18 are configured to move relative to the adjacent passenger seats 12, 14 on the base 34. It is contemplated that the first and second console modules may be slidably mounted to the base by a variety of mechanisms, including rails, guides or the like, which will be discussed in greater detail below. However, it is understood that the first and second console modules may be mounted to and adjusted relative to the base or vehicle floor by a variety of other mechanisms.

First and second console module 16, 18 of the console assembly 10 in connection with a first aspect of the present invention are configured to receive a variety of convenience items. As shown in FIGS. 1 and 2, first console module 16 includes a slot 36 which receives a cup holder 38. Cup holder 38 includes a mechanism allowing it to move between a stored position disposed at least partially within the slot 36 and a deployed position shown in FIG. 1 extending from the first console module 38.

The covers or armrests extending over the first and second console modules may be configured to perform additional functions. For example, as shown in FIG. 2, one or more cup holders 40 are formed in cover 32 extending over a storage area (not shown) in the first console module 16. Alternatively, cover 42 disposed on the second console module 18 includes a recess 44 formed in a top surface of the cover which may receive and secure small items such as mobile telephones, sunglasses, or the like. In addition, as illustrated in FIGS. 3 and 4, the console modules may include one or more secondary storage areas 45 formed therein with a cover 46 extending thereover to provide additional storage for the vehicle.

Referring now to FIGS. 2-4, first and second console modules 16, 18 are shown in various positions on the base 34. First and second console modules 16, 18 may be moved to various positions relative to the passenger seats. For example, first and second modules 16, 18 may be positioned adjacent one another adjacent a forward portion 48 of base 34, as shown in FIG. 2, or a rearward portion 50 as shown in FIG. 3.

Alternatively, first and second console modules 16, 18 may be extended away from each other such that first console module 16 is positioned adjacent the forward portion 48 of base 34, while the second console module 18 is positioned adjacent the rearward portion 50 of the base 34. In this expanded position, first and second console modules 16, 18 define a storage area 52 therebetween sized to receive various items, such as a purse 53 or the like. It is also contemplated that the storage area in the second console module 18 may form a bin 54 for refuse or the like.

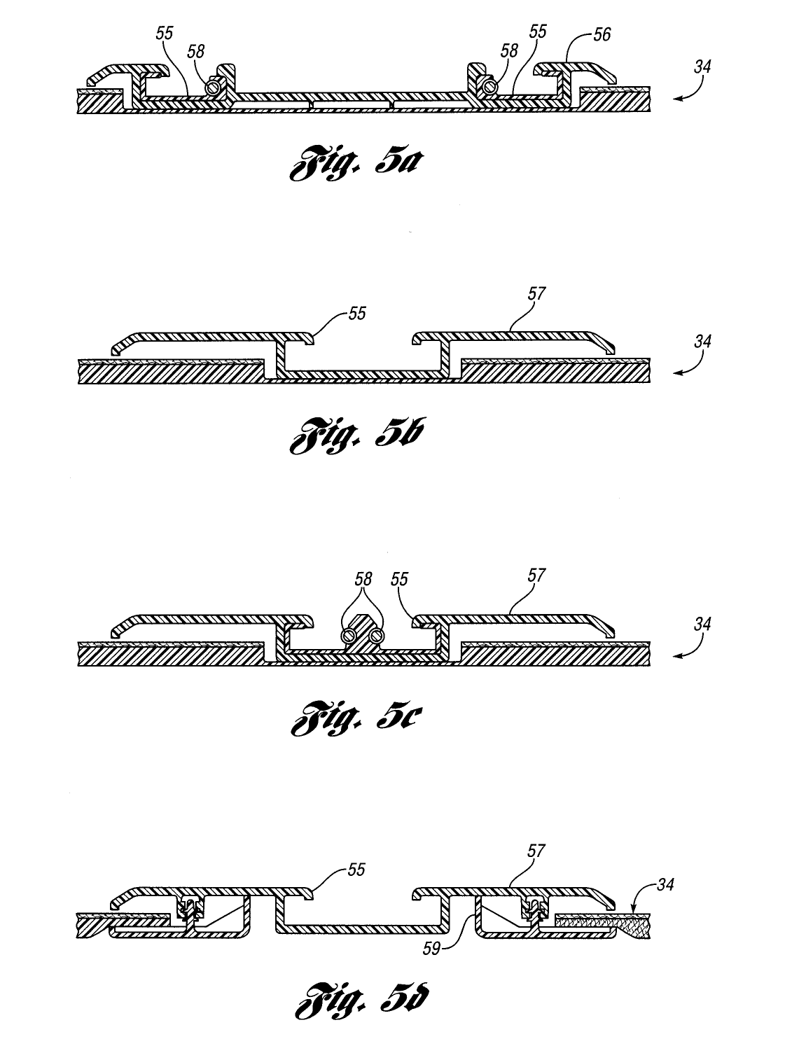

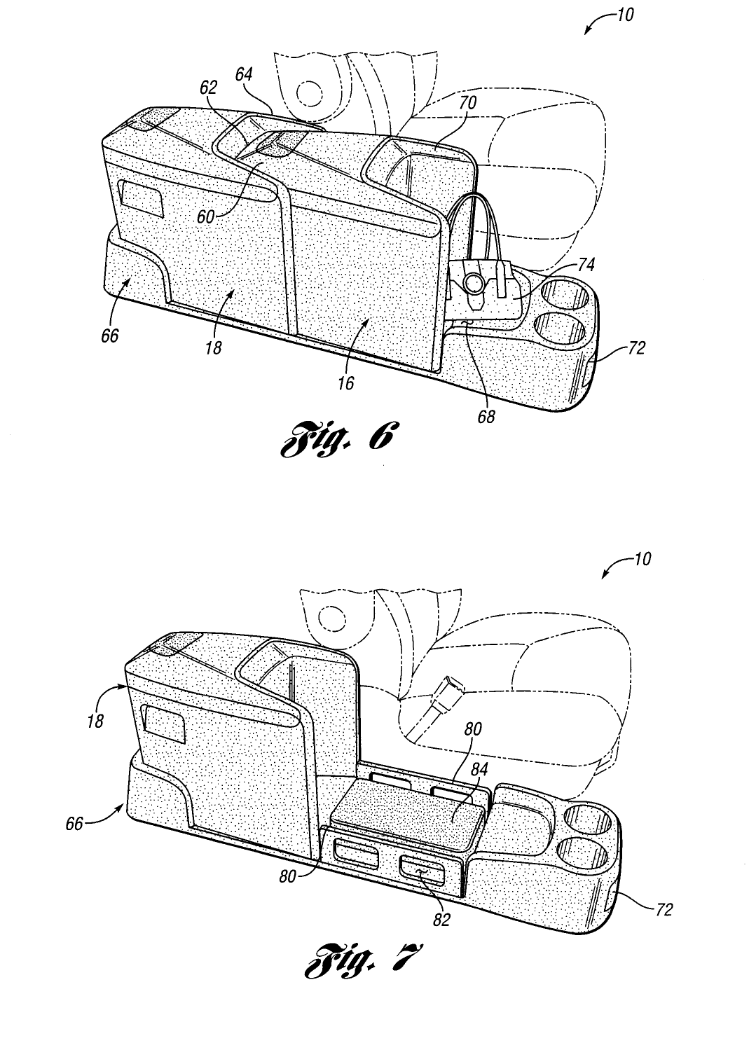

FIGS. 5a-5d showing exemplary non-limiting mounting arrangements which may be used to adjust the first and second console modules of the console assembly of the present invention forward and rearward on the base. It is understood that a variety of other mounting arrangements, including sliding mechanisms, fastening arrangements and mechanical interaction between the modules and the base or vehicle floor may be used to accomplish the same objectives.

Referring now to FIG. 5a, base or support surface 34 comprises a pair of channels or rails 55 which are configured to receive portions of the first and second console modules. In one aspect of the present invention, a pair of projections from each console module may be inserted into rails 55, thereby guiding the console modules through the rails and along the base 34. In another aspect of the present invention, one rail may be configured to receive a projection from the first console module while the second rail may be configured to receive a projection from the second console module. Rails may be formed as part of the base or, as shown in FIG. 5a, may be an insert 56 secured within the base 34.

In another mounting arrangement shown in FIGS. 5b-5d, a single rail 55 receives one or more projections from the first and second console modules, allowing the modules to slide forward and rearward relative to the base 34. Rail 55 may be integrally formed into the base or formed as part of an insert 57 disposed within the base 34. Electrical contacts 58 may be formed into insert 57 as shown in FIGS. 5a and 5c to provide power and electronics for devices or removable accessories mounted to or disposed in the console modules. It is also contemplated, as shown in FIG. 5d, that a substructure or clamp strip 59 may be mounted to base 34 which receives and secures insert 57 into position in the base 34. The first and second console modules, once slidably connected to one or more guide rails on the base, are allowed to be independently positionable forward and rearward on the base as described above.

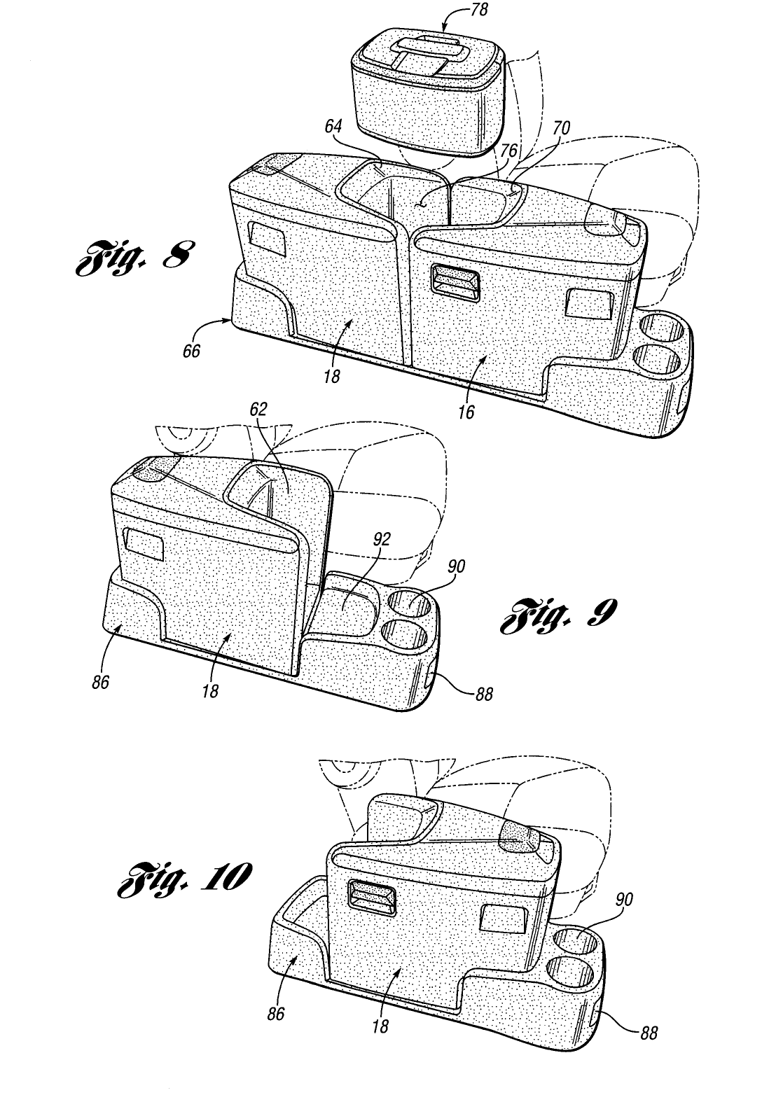

Referring now to FIGS. 6-10, a second aspect of the console assembly 10 of the present invention is discussed in greater detail. Modules 16, 18 may be configured to support a nesting arrangement, as shown in FIG. 6, or a mating arrangement, as shown in FIG. 8. Similar terms and numerals are used for similar components illustrated in the Figures. While the first and second console modules shown in FIGS. 6-10 are shown in different configurations than those shown in FIGS. 1-4, it is understood that the console modules, regardless of configuration, generally include similar components, including a housing, one or more storage areas defined within the housing and a cover or armrest at least partially disposed above the one or more storage areas.

With respect to the arrangement shown in FIG. 6, first and second console modules 16, 18 are formed to similar cross-sectional shape such that, a first end 60 of console module 16 fits within a recess 62 in a second end 64 of console module 18. Base 66 is configured to receive and secure modules 16, 18 such that a storage area 68 is formed between the second end 70 of console module 16 and a forward portion 72 formed in the base 66. Storage area 68 provides additional storage for items such as purses 74 or the like.

Referring now to FIG. 8, console modules 16, 18 are configured in base 66 such that the second end 64 of console module 18 is positioned adjacent the second end 70 of console module 16. In this position, a cavity 76 is formed between console modules 16, 18 which is sized to receive a removable storage module 78. It is also understood that the storage area 68 shown in FIG. 6 is sized to receive the removable storage module 78. Removable storage module 78 may provide any number of storage options, such as storage for personal items or a cooler for storing food and beverage. It is also contemplated that the removable storage module may include power contacts that can be connected to matching contacts on the console assembly to provide power to the removable storage module.

Referring now to FIGS. 7, 9 and 10, alternate base arrangements for the console assembly 10 of the present invention are illustrated and described. FIG. 7 illustrates a base 66 with the first console module removed from therefrom and the second console module 18 mounted in a rearward facing arrangement. Base 66 includes one or more doors or panels 80 that are pivotally mounted adjacent the lower surface 82 of the base. Doors 80 are placed in an open position such that a removable item, such as a day planner 84, is securely placed therebetween to keep the removable items from shifting around the passenger seating area. Doors 80 cooperate with the lower surface 82 and the forward portion 72 of the base 66 to receive and secure the removable items 84.

Referring now to FIGS. 9 and 10, base 86 is configured to receive a single console module 18 in either a forward facing position illustrated in FIG. 9 or a rearward facing position in FIG. 10. Base 86 includes a forward portion 88 having one or more cup holders 90 formed therein. Base 86 cooperates with recess 62 in the second end of the second console module 18 to provide additional storage 92 for the passenger compartment of the vehicle as shown in FIG. 9.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A console assembly for use with a passenger seating area of a vehicle, the console assembly comprising first and second console modules configured for installment in the passenger seating area, each console module including a housing having a storage area defined therein, wherein the first and second console modules cooperate with and are positionable relative to each other to provide additional storage in the vehicle.

2. The console assembly of claim 1 further comprising a base disposed adjacent a floor of the passenger seating area of the vehicle configured to receive the first and second console modules.

3. The console assembly of claim 2 wherein each console module housing further comprises a lower surface configured for mounting on the base, a front surface, a rear surface and a pair of opposing side surfaces each extending upward from the base and cooperating with each other to form the storage area therebetween.

4. The console assembly of claim 2 further comprising a cover connected to the console module housing adjustably positionable between a stowed position disposed at least partially adjacent a top surface of the console module housing and a deployed position, wherein the top surface of the cover includes one or more recesses formed therein to provide additional storage for the vehicle.

5. The console assembly of claim 1 wherein the housing of the one or more of the first and second console modules further comprise a cup holder connected to the housing by a mechanism to be positionable between a stored position disposed at least partially within a slot in the module and a deployed position extending generally upward from the housing.

6. The console assembly of claim 2 wherein the first and second console modules are slidably connected to the base and each are positionable forward and rearward on the base.

7. The console assembly of claim 6 wherein the first and second console modules are slidably connected to one or more guide rails on the base thereby allowing each of the first and second console modules are independently positionable forward and rearward on the base.

8. The console assembly of claim 2 wherein the housing of each of the first and second console modules include a first end and opposing second end sized for connection to and repositionable on the base to provide a variety of storage solutions and a storage area therebetween.

9. The console assembly of claim 8 wherein the housing of each of the first and second console modules are positioned in a nesting arrangement wherein the first end of one console module may be positioned adjacent the second end of another console module.

10. The console assembly of claim 8 wherein the housing of the first and second console modules are formed in a similar shape in cross-section such that the modules may be positioned in a mating arrangement such that the second ends of each of the first and second modules are positioned adjacent each other to form a storage area therebetween.

11. The console assembly of claim 10 wherein a removable storage module is received in the storage area between the second ends of the second ends of the first and second console modules.

12. A console assembly for use with a passenger seating area of a vehicle, the console assembly comprising:
a base disposed on a floor of the passenger seating area having a forward portion and an opposing aft portion;
first and second console modules configured for installment on the base, the first and second console modules each having a housing and a storage area defined therein,
wherein the first and second console modules cooperate with and are positionable relative to each other to provide additional storage in the vehicle.

13. The console assembly of claim 12 wherein the housing of each of the first and second console modules housing comprises a lower surface configured for installment on the base, a front surface, a rear surface and a pair of opposing side surfaces each extending upward from the base and cooperating with each other to form the storage area therebetween.

14. The console assembly of claim 13 wherein the lower surface of the housing of the first and second console modules are slidably connected to the base and each are positionable forward and rearward on the base.

15. The console assembly of claim 14 wherein the first and second console modules are slidably connected to one or more guide rails on the base thereby allowing each of the first and second console modules are independently positionable forward and rearward on the base.

16. The console assembly of claim 12 wherein a cover is connected to the console module housing and is adjustably positionable between a stowed position disposed at least partially adjacent a top surface of the console module housing and a deployed position.

17. A console assembly for use with a passenger seating area of a vehicle, the console assembly comprising:
a base disposed on a floor of the passenger seating area having a forward portion and an opposing aft portion;
first and second console modules configured for installment on the base, the first and second console modules each having a housing and a storage area defined therein,
wherein the housing of each of the first and second console modules include a first end and opposing second end sized for connection to and repositionable on the base to provide a variety of storage solutions and a storage area therebetween.

18. The console assembly of claim 17 wherein the housing of each of the first and second console modules are positioned in a nesting arrangement wherein the first end of one console module may be positioned adjacent the second end of another console module.

19. The console assembly of claim 17 wherein the housing of the first and second console modules are formed in a similar shape in cross-section such that the modules may be positioned in a mating arrangement such that the second ends of each of the first and second modules are positioned adjacent each other to form a storage area therebetween.

20. The console assembly of claim 17 wherein a removable storage module is received in the storage area between the second ends of the second ends of the first and second console modules.
